(19) United States
(12) Patent Application Publication
(10) Pub. No.: US 2005/0098047 A1
(43) Pub. Date: May 12, 2005

(54) Oven shelf with heat shield that prevents bottom surface burning of baked goods

(76) Inventor: Dan Steinberg, Blacksburg, VA (US)

Correspondence Address: Dan Steinberg, 2301 Glade Road, Blacksburg, VA, 24060, US

(21) Appl. No.: 10/983,767

(22) Filed: Nov. 8, 2004

Related U.S. Application Data
(60) Provisional application No. 60/518,121, filed on Nov. 7, 2003.
(60) Provisional application No. 60/580,168, filed on Jun. 16, 2004.

(51) Int. Cl. A47J 9/00

(52) U.S. Cl. 99/450

(57) ABSTRACT

Baked goods are often burned by exposure to heat radiation (infrared rays) from heating coils in an electric baking oven. The infrared rays strike the bottom surface of bakeware and heat the surface to the point of burning. The present invention provides a heat shield that protects the bakeware from infrared rays and burning. The present invention comprises a sheet disposed under a wire baking rack. The sheet blocks infrared rays and can be make of sheet metal. The sheet can be suspended by hooks, for example. In another aspect of the invention, the sheet is disposed on top of the wire baking rack. In this embodiment, the sheet has corrugations or bumps that provide only line contact or point contact with the bakeware. Hence, an insulating air layer is provided between the sheet and the bakeware.

### RELATED APPLICATIONS

The present application claims the benefit of priority from copending provisional patent application 60/518,121 filed on Nov. 7, 2003, and from copending provisional patent application 60/580,168, filed on Jun. 16, 2004.

### FIELD OF THE INVENTION

The present invention relates generally to oven bakeware and baking supplies. More particularly, the present invention relates to a simple device for preventing bottom surface burning of baked goods such as cookies, cakes, pies and bread.

### BACKGROUND OF THE INVENTION

Cooking ovens, particularly electric models, have a tendency to burn or overcook the bottom portion of baked goods such as cookies, cakes, pies and breads. This typically results from infrared radiation striking the bottom of the cookie sheet or breadpan and heating it to an excessive temperature. Insulated (2-layer) cookie sheets are commonly used to avoid this problem. However, insulated breadpans or piepans are generally not available and insulated cookie sheets tend to be expensive. Also, insulated cookie sheets can still burn the bottom portion if the cookie sheet is a dark color (e.g. from baked-on food spills) that absorbs radiation.

It would be desirable to provide an inexpensive oven accessory or oven design that minimizes or eliminates burning of the bottom portion of baked goods. It would be particularly useful to provide an anti-burn baking accessory that can be used with a wide variety of bakeware (e.g. cookie sheets, breadpans and piepans).

### SUMMARY

The present invention includes a baking oven shelf for supporting bakeware having a wair baking rack comprising a plurality of wires arranged in a grid, and a metallic heat shield below the wire baking rack. The heat shield is suspended from the wire baking rack.

The heat shield can be less than 2 inches below the wire baking rack.

The heat shield can be suspended by hooks, tabs or brackets, for example.

The heat shield can also have holes.

The present invention also includes a heat shield disposed on top of the wire baking rack. In this case, the heat shield comprises corrugations or bumps. The corrugations or bumps create an insulating air layer between the heat shield and the bakeware.

The corrugations or bumps can make line or point contact with the bakeware. The corrugations or bumps can have heights of about 0.1-1 inches, for example.

### DESCRIPTION OF THE FIGURES

FIG. 1 shows an oven shelf with a suspended heat shield according to the present invention.

FIG. 2 shows an oven shelf with a heat shield suspended with L-shaped brackets.

FIG. 3 shows a wire baking rack with L-shaped brackets according to the present invention.

FIG. 4 shows the oven shelf with a heat shield having tabs.

FIG. 5 shows a perspective view of a heat shield with tabs.

FIG. 6 shows the oven shelf with a heat shield having corrugations or bumps. The heat shield is disposed on top of the wire baking rack.

FIG. 7 shows a heat shield with bumps.

FIG. 8 shows a heat shield with corrugations.

FIG. 9 shows a corrugated heat shield with flat tops that provide 2 dimensional contact with bakeware.

### DETAILED DESCRIPTION

The present invention provides a baking oven shelf for supporting bakeware (e.g. pie pans, cookie sheets, bread pans, cake forms). The present baking oven shelf prevents bottom surface burning of baked goods such as cookies, cakes, pies and breads. The present oven shelf includes a heat shield suspended below and from a wire baking rack, or disposed on top of the wire baking rack. The heat shield comprises sheet metal, preferably. The heat shield may be suspended below the wire rack by hooks or brackets or tabs, for example. If the heat shield is disposed on top of the wire rack, it must have corrugations or bumps to create an insulating air space between the heat shield and bakeware. The present heat shield prevents infrared radiation from striking and directly heating the bakeware. The present heat shield can be used with all kinds of bakeware, and obviates the use of insulated bakeware such as 2-layer cookie sheets.

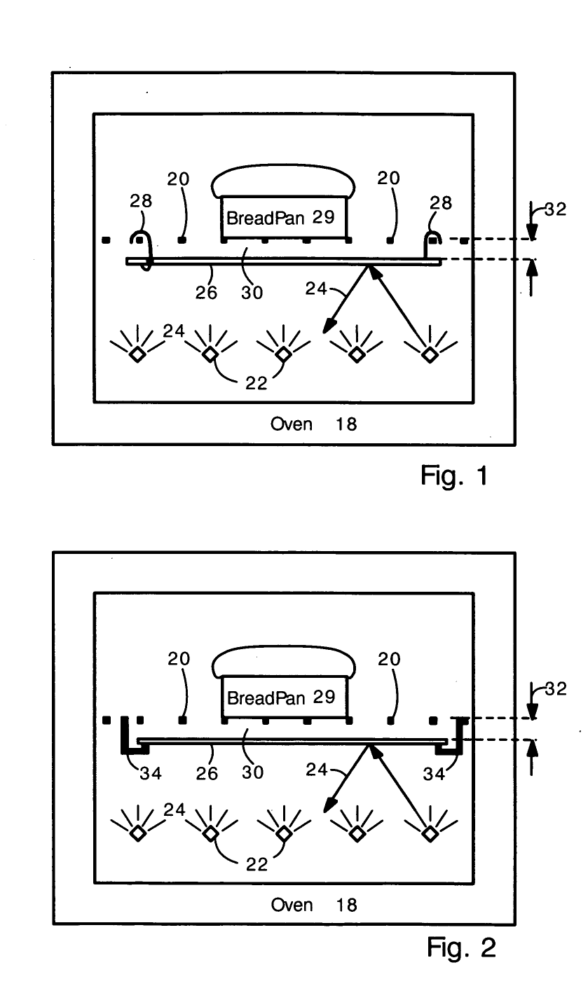

FIG. 1 shows a front view (i.e. view through an open oven door) of an oven 18 with an oven shelf according to the present invention. The oven shelf comprises a wire baking rack 20. The wire rack has a regular array of wires arranged in a grid, as is conventionally known. The oven 18 may have slots (not shown) for receiving and supporting the wire rack 20. The oven 18 includes electrical heating coils 22. The heating coils emit infrared radiation 24. The present invention includes a heat shield 26 suspended below the wire baking rack 20. In the particular example of FIG. 1, the heat shield 26 is suspended by hooks 28. The wire baking rack supports bakeware 29 such as a breadpan (shown), cookie sheet or pie pan (not shown).

The heat shield 26 can comprises sheet metal such as aluminum, stainless steel, or tin-plated steel. The heat shield can have a thickness of about 0.010-0.35 inches, for example.

The wire baking rack 20 can comprise a wire grid. Baking ovens commonly have wire grid baking racks, as well known in the art.

An insulating air layer 30 is disposed between the heat shield 26 and the bakeware 29. The insulating air layer 30 can have a thickness 32 of about 0.1-1 or 2 inches. The thickness 32 of the air insulating layer is determined by the length of the hooks 28.

The heat shield 26 is opaque to infrared radiation. The heat shield can be reflective or absorptive to infrared radiation.

In operation, the heat shield 26 prevents infrared radiation from directly heating the bottom surface of the bakeware 29. The heat shield 26 absorbs or reflects infrared radiation 24. Hence, the bakeware and baking goods are heated by contact with hot air, and indirect infrared radiation (i.e. infrared emitted from oven sidewalls or heat shield). In this way, the present heat shield 26 prevents bottom surface burning of the food within the bakeware 29.

FIG. 2 shows an embodiment of the invention in which the heat shield 26 is suspended by L-shaped brackets 34. The brackets 34 are attached to the wire baking rack 20. The L-brackets 34 can be made of steel and permanently welded to the wire rack 20. The brackets 34 may allow the heat shield 26 to slide into and out of the oven 18.

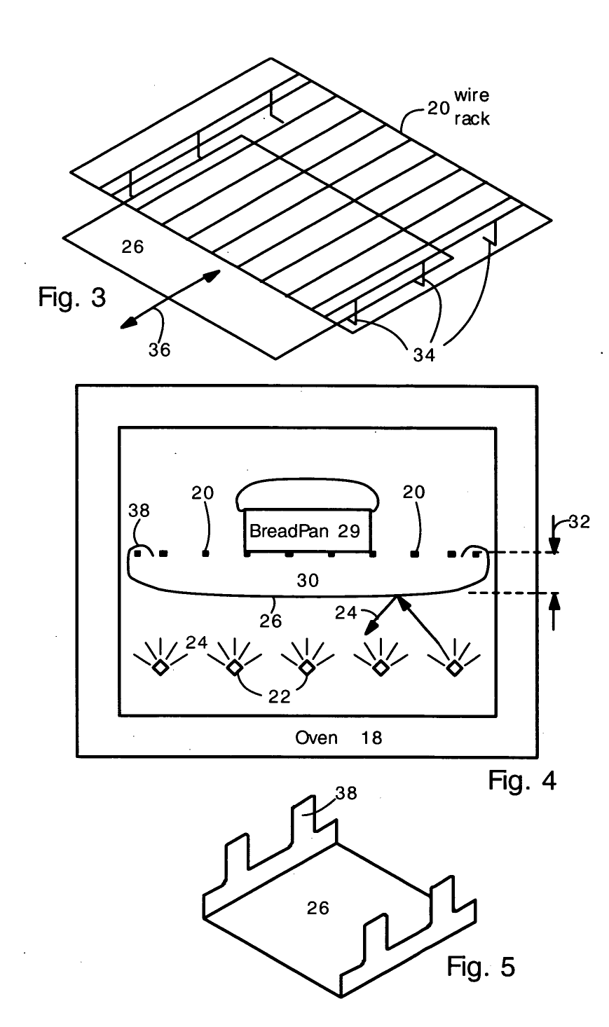

FIG. 3 shows the wire rack 20, L-brackets 34 and heat shield of FIG. 2. The heat shield can be removed and inserted by sliding in the direction of the arrows 36. The heat shield can be shaped like a tray, with upturned edges (not shown).

FIG. 4 and FIG. 5 illustrate another embodiment in which the heat shield 26 has tabs 38 for suspending the heat shield 26. The tabs 38 are wrapped partially around the wire baking rack 20. In this embodiment, the heat shield can be made of thin, bendable sheet metal so that it can be bent around the wire rack 20 by hand.

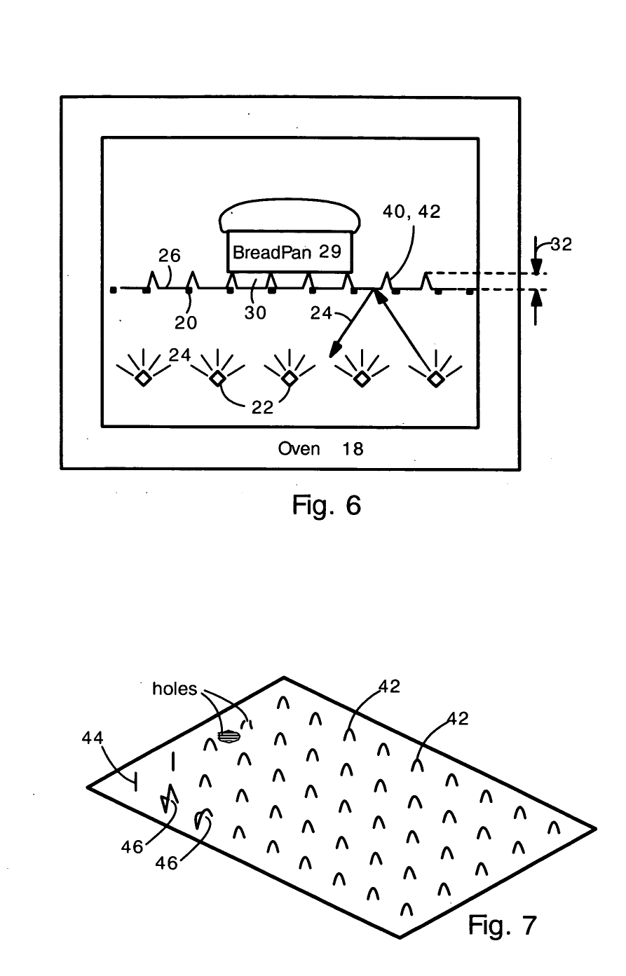

FIG. 6. illustrates another embodiment in which the heat shield 26 comprises corrugations 40 or bumps 42. The height of the corrugations or bumps will be the same as the thickness 32 of the insulating air layer 30. The thickness 32 of the air layer 30 (and height of the bumps 42 or corrugations 40) can be about 0.1 to 1 inches, or, preferably, about 0.25-0.5 inches. The corrugations 40 or bumps 42 can be formed by rolling or stamping of sheet metal, for example. The corrugations or bumps should be designed so that only line contact or point contact occurs between the bakeware 29 and the corrugations or bumps. With the area of contact limited to line contact or point contact, the heat transfer between the heat shield and bakeware will be minimized. Preferably, the area of contact between the heat shield and bakeware will be less than 20%, 10%, 5%, or preferably, 2% of the total area.

FIG. 7 shows a perspective view of a heat shield with bumps 42 according to the present invention. The bumps 42 are arranged in a grid pattern (though a grid pattern is optional in the invention). Preferably, all the bumps 42 are similarly formed, and have similar heights. The bumps 42 should located be close enough to one another so that bakeware 29 will be stable supported (e.g. in contact with at least 3 bumps). Typically, the bumps should be separated by about 1-2 inches.

It is noted that the bumps 42 can comprise small needles or wire points 44 that support the bakeware by the tips. Also, the bumps can comprise small sections (e.g. triangles, half-circles) of heat shield material cut and bent upwardly 46. Such features will have a very small contact area with the bakeware 29.

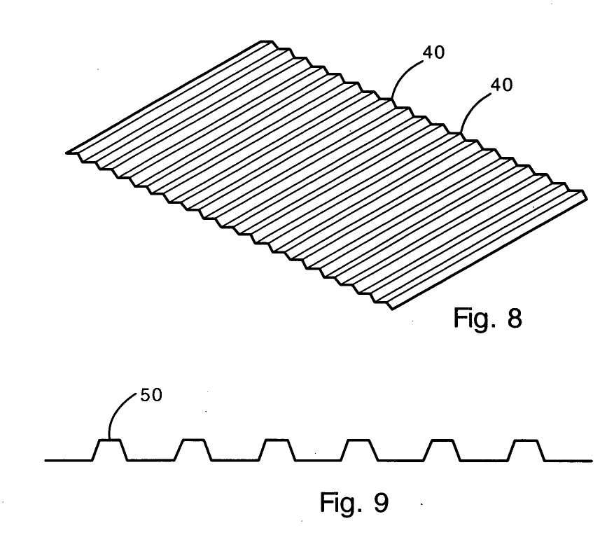

FIG. 8 shows a perspective view of a heat shield having corrugations 40. It is important to note that the corrugations do not need to be straight lines as shown in FIG. 8. Curved or wavy corrugations are within the scope of the present invention and appended claims. The corrugations 40 should be located close enough to one another so that bakeware 29 will be stably supported (e.g. in contact with at least 2 or 3 corrugations). Typically, the corrugations should be separated by less than 1-2 inches. It is noted that the corrugations can have flat bottoms and flat tops, so that the heat shield and bakeware have more than line or point contact (i.e. 2-dimensional contact). For example, the heat shield and bakeware can have 20% or 30% contact. Such contact can provide for bottom surface browning of baked goods. FIG. 9, for example, shows a corrugated heat shield with raised flat areas 50 that will provide about 25% contact with bakeware.

The present heat shield can have a wide range of sizes, but will typically be designed to be slightly smaller than a conventional oven rack. For example, a conventional oven rack typically has dimensions of about 17×20 inches. The present heat shield can be about 15×18 inches. With the heat shield slightly smaller than the oven rack, a gap is provided around the perimeter of the heat shield so that air may circulate throughout the oven.

It is also noted that the heat shield can have holes so that a small portion of infrared radiation (e.g. less than 50% or 25%) passes through the heat shield 26. A heat shield 26 with holes may provide a controlled amount of bottom surface browning. Bottom surface browning may be desired in certain baking applications (e.g. if a crisp crust is desired). Holes can be located on the bumps or corrugations, or on flat areas of the heat shield.

The present invention provides an oven shelf that prevents bottom surface burning of baked goods. The present oven shelf can prevent bottom surface burning in a wide variety of bakeware such as cookie sheets, pie pans, breadpans and the like.

It will be clear to one skilled in the art that the above embodiment may be altered in many ways without departing from the scope of the invention. Accordingly, the scope of the invention should be determined by the following claims and their legal equivalents.

1. A baking oven shelf for supporting bakeware, comprising:
a) a wire baking rack comprising a plurality of wires arranged in a grid;
b) a metallic heat shield below the wire baking rack, and suspended from the wire baking rack.

2. The oven shelf of claim 1 wherein the heat shield is suspended less than 2 inches below the wire baking rack.

3. The oven shelf of claim 1 wherein the heat shield is suspended by hooks.

4. The oven shelf of claim 1 wherein the heat shield is suspended by tabs on the heat shield.

5. The oven shelf of claim 1 wherein the heat shield is suspended by L-brackets.

6. The oven shelf of claim 1 wherein less than 50% of the heat shield comprises holes.

7. The oven shelf of claim 1 wherein less than 25% of the heat shield comprises holes.

8. An oven shelf for supporting bakeware, comprising:
a) a wire baking rack comprising a plurality of wires arranged in a grid;
b) a heat shield disposed on top of the wire baking rack, wherein the metallic heat shield comprises corrugated or bumpy sheet metal.

9. The oven shelf of claim 8 wherein the heat shield corrugations or bumps are shaped so that the heat shield makes line contact or point contact with the bakeware.

10. The oven shelf of claim 8 wherein the corrugations or bumps have heights in the range of 0.1-1 inches.

11. The oven shelf of claim 8 wherein the heat shield corrugations or bumps are shaped so that less than 10% of total surface area of bakeware and

12. The oven shelf of claim 8 wherein less than 50% of the heat shield comprises holes.

13. The oven shelf of claim 8 wherein less than 25% of the heat shield comprises holes.

14. The oven shelf of claim 8 wherein all the corrugations or bumps have the same height.

15. The oven shelf of claim 8 wherein the heat shield comprises flat portions that provide 2 dimensional contact with bakeware.

16. A heat shield for preventing bottom surface burning of baked goods, comprising:
a piece of sheet metal having corrugations or bumps with a height in the range of 0.1-1 inches.
